(19) United States
(12) Patent Application Publication
(10) Pub. No.: US 2026/0230726 A1
(43) Pub. Date: Aug. 6, 2026

(54) SOLID-STATE IMAGING ELEMENT

(71) Applicant: SONY SEMICONDUCTOR SOLUTIONS CORPORATION, KANAGAWA (JP)

(72) Inventor: TAKANORI YAGAMI, KANAGAWA (JP)

(21) Appl. No.: 19/156,018

(22) PCT Filed: Jan. 15, 2024
(86) PCT No.: PCT/JP2024/000782

§ 371 Date: Aug. 13, 2025

(30) Foreign Application Priority Data
Feb. 28, 2023 (JP) 2023-029890

(51) Int. Cl. H04N 25/63; H04N 25/78; H04N 25/79

(52) U.S. Cl. CPC H04N 25/63; H04N 25/78; H04N 25/79

(57) ABSTRACT

To provide a solid-state imaging element capable of improving deterioration of dark current characteristics caused by current source transistors. A solid-state imaging element according to one aspect of the present disclosure includes a light receiving circuit that performs photoelectric conversion on incident light, and a reading circuit that reads a signal obtained as a result of photoelectric conversion by the light receiving circuit. In this solid-state imaging element, the reading circuit includes one or more current source transistors and one or more switch elements connected between the current source transistors and ground.

### TECHNICAL FIELD

The present disclosure relates to a solid-state imaging element.

### BACKGROUND ART

Examples of a solid-state imaging element include a CMOS image sensor that reads, via metal oxide semiconductor (MOS) transistors, photocharge accumulated in pn junction capacitors of photodiodes that are photoelectric conversion elements. In a CMOS image sensor, a configuration including light receiving circuits including the photoelectric conversion elements and reading circuits that read signals subjected to photoelectric conversion by the light receiving circuits is known. The reading circuits are generally provided with current source transistors.

When a current flows through the current source transistors, hot carrier luminescence can be generated. Furthermore, the current source transistors are controlled in such a way as to be driven also during a charge accumulation period of the photoelectric conversion elements. Therefore, a situation is assumed in which hot carrier luminescence is received by the photoelectric conversion elements during the charge accumulation period. When such a situation occurs, dark current characteristics of the solid-state imaging element can deteriorate.

### CITATION LIST

### Patent Document

Patent Document 1: WO 2021/192576 A

### SUMMARY OF THE INVENTION

### Problems to be Solved by the Invention

Therefore, the present disclosure provides a solid-state imaging element capable of improving deterioration of dark current characteristics caused by current source transistors.

### Solutions to Problems

A solid-state imaging element according to one aspect of the present disclosure includes a light receiving circuit that performs photoelectric conversion on incident light, and a reading circuit that reads a signal obtained as a result of photoelectric conversion by the light receiving circuit. In this solid-state imaging element, the reading circuit includes one or more current source transistors and one or more switch elements connected between the current source transistors and ground.

The reading circuit may further include:
a source follower circuit disposed at a subsequent stage of the light receiving circuit; and
a current mirror circuit disposed at a subsequent stage of the source follower circuit,
the source follower circuit may include a first current source transistor among the current source transistors, and
the current mirror circuit may include a second current source transistor among the current source transistors, which is different from the first current source transistor.

A first switch element among the switch elements may be connected between the first current source transistors and the ground.

A second switch element among the switch elements may be connected between the second current source transistors and the ground.

A first switch element among the switch elements may be connected between the first current source transistor and the ground, and
a second switch element among the switch elements, which is different from the first switch element, may be connected between the second current source transistor and the ground.

A gate wiring of the first switch element may be made common with a gate wiring of the second switch element.

One of the switch elements may be commonly connected to the first current source transistor and the second current source transistor.

The switch element may include an n-channel MOS transistor.

The switch element may include a p-channel MOS transistor.

Gate wirings of the switch elements may be parallel to a gate wiring of the first current source transistor or the second current source transistor.

The gate wiring of the first current source transistor or the second current source transistor may be disposed between the gate wiring of the first switch element among the switch elements and the second switch elements among the switch elements, which is different from the first switch element.

A plurality of the switch elements may be connected in parallel with the first current source transistor and the second current source transistor.

The ground may be made common between the first switch element and the second switch element.

The solid-state imaging element may further include a pixel drive circuit that controls driving of the switch elements.

The light receiving circuit may include a photoelectric conversion element that accumulates charge obtained as a result of the photoelectric conversion of the incident light, and
the pixel drive circuit turns off the switch elements during a charge accumulation period of the photoelectric conversion element.

The light receiving circuit, the current source transistors, and the switch elements may be disposed in a same chip.

The solid-state imaging element may further include:
a first chip in which the light receiving circuit, the current source transistors, and the switch elements are disposed; and
a second chip that is stacked on the first chip and on which a part of the reading circuit is disposed.

### BRIEF DESCRIPTION OF DRAWINGS

FIG. 1 is a block diagram illustrating a configuration example of an imaging device according to a first embodiment.

FIG. 2 is a diagram for explaining an example of use of an imaging element illustrated in FIG. 1.

FIG. 3 is a diagram illustrating an example of a multilayer structure of a solid-state imaging element.

FIG. 4 is a block diagram illustrating a configuration example of a first chip.

FIG. 5 is a block diagram illustrating a configuration example of a second chip.

FIG. 6 is a diagram illustrating an example of circuit configuration of the solid-state imaging element according to the first embodiment.

FIG. 7 is a timing chart for explaining operation of the solid-state imaging element according to the first embodiment.

FIG. 8 is a diagram illustrating an example of circuit configuration of a solid-state imaging element according to a second embodiment.

FIG. 9 is a diagram illustrating an example of circuit configuration of a solid-state imaging element according to a third embodiment.

FIG. 10 is a diagram illustrating an example of circuit configuration of a solid-state imaging element according to a fourth embodiment.

FIG. 11 is a diagram illustrating an example of circuit configuration of a solid-state imaging element according to a fifth embodiment.

FIG. 12 is a diagram illustrating an example of circuit configuration of a solid-state imaging element according to a sixth embodiment.

FIG. 13 is a diagram illustrating an example of a layout of gate wirings of switch elements according to the sixth embodiment.

FIG. 14 is a diagram illustrating an example of circuit configuration of a solid-state imaging element according to a seventh embodiment.

FIG. 15 is a diagram illustrating an example of circuit configuration of a solid-state imaging element according to an eighth embodiment.

FIG. 16 is a block diagram illustrating a schematic configuration example of a vehicle control system.

FIG. 17 is an explanatory diagram illustrating an example of an installation position of an imaging section.

### MODE FOR CARRYING OUT THE INVENTION

Embodiments of an imaging device will be described hereinafter with reference to the drawings. Although main components of the imaging device will be mainly described below, the imaging device can include components and functions that are not illustrated or described. The following description is not intended to exclude components and functions that are not illustrated or described.

The drawings are schematic or conceptual, and a ratio of each part and the like are not necessarily the same as actual ones. In the specification and the drawings, elements similar to those described before with reference to preceding drawings will be denoted by the same reference signs, and detailed description thereof is appropriately omitted.

### First Embodiment

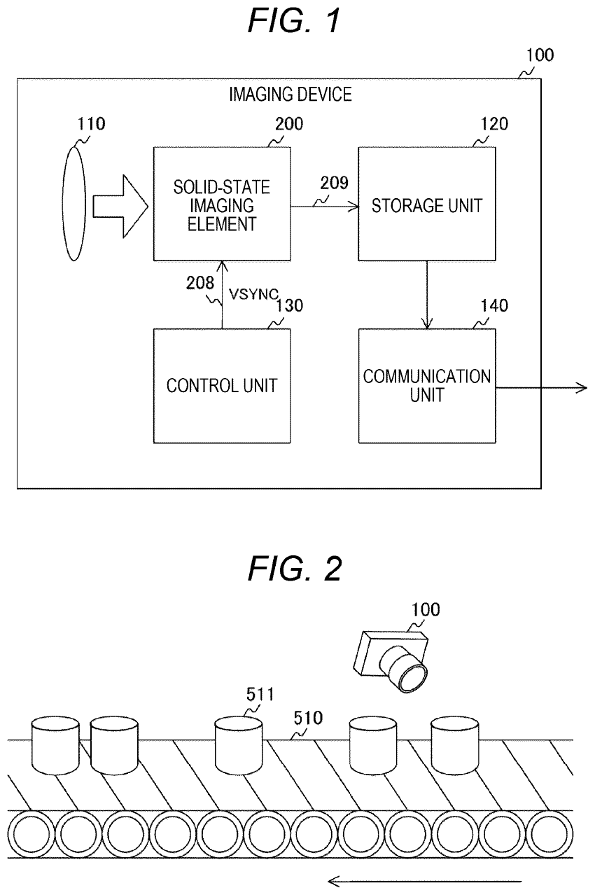

FIG. 1 is a block diagram illustrating a configuration example of an imaging device according to a first embodiment. An imaging device 100 illustrated in FIG. 1 includes an optical unit 110, a solid-state imaging element 200, a storage unit 120, a control unit 130, and a communication unit 140.

The optical unit 110 condenses incident light and guides the light to the solid-state imaging element 200. The solid-state imaging element 200 is an example of a solid-state imaging element in the present disclosure. Image data obtained by the solid-state imaging element 200 is transmitted to the storage unit 120 via a signal line 209.

The storage unit 120 stores various types of data such as the image data and a control program of the control unit 130. The control unit 130 controls the solid-state imaging element 200 in such a way as to obtain image data. For example, the control unit 130 supplies a vertical synchronization signal VSYNC to the solid-state imaging element 200 via a signal line 208. The communication unit 140 reads the image data from the storage unit 120 and transmits the image data to the outside.

FIG. 2 is a diagram for explaining a use example of the imaging device 100. As illustrated in FIG. 2, the imaging device 100 is used, for example, in a factory or the like where a belt conveyor 510 is provided.

The belt conveyor 510 moves subjects 511 in a predetermined direction at a constant speed. The imaging device 100 is fixed in the vicinity of the belt conveyor 510, and generates image data by imaging the subjects 511. The image data is used, for example, for inspection of presence or absence of a defect. As a result, factory automation (FA) is achieved.

Note that the imaging device 100 images the subjects 511 moving at the constant speed, but the configuration is not limited to this. The imaging device 100 may be configured to perform imaging while moving at a constant speed with respect to subjects, such as aerial imaging.

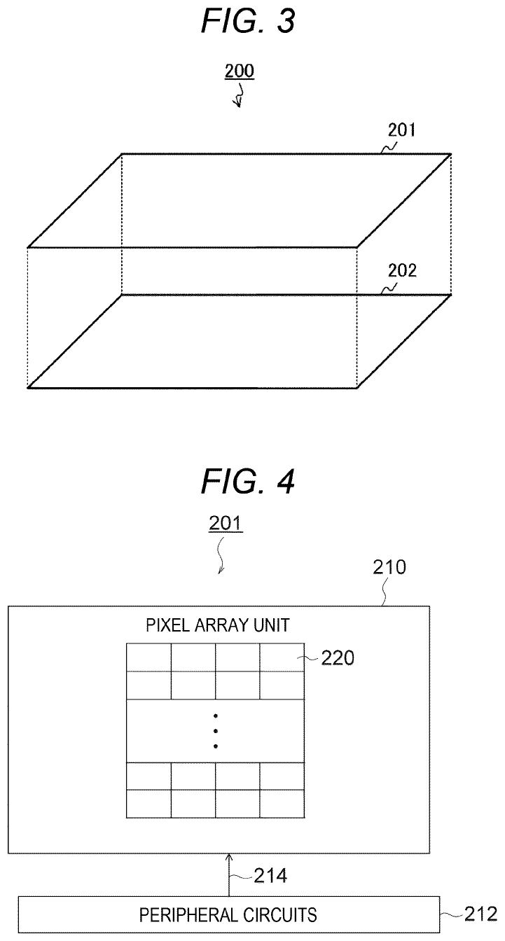

FIG. 3 is a diagram illustrating an example of a multilayer structure of the solid-state imaging element 200. The solid-state imaging element 200 includes a first chip 201 and a second chip 202 stacked on the first chip 201. These chips are electrically connected to each other via joints such as vias. Note that the chips may be connected to each other by Cu—Cu bonding or bumps, instead of the vias.

FIG. 4 is a block diagram illustrating a configuration example of the first chip 201. A pixel array unit 210 and peripheral circuits 212 are disposed on the first chip 201.

In the pixel array unit 210, a plurality of pixels 220 is arranged in a matrix (in a two-dimensional array). Each pixel 220 performs photoelectric conversion on incident light to generate an analog signal. In the peripheral circuits 212, a circuit that supplies a direct current (DC) voltage such as a power supply voltage VDD to the pixel array unit 210 via a power supply line 214 and the like are arranged.

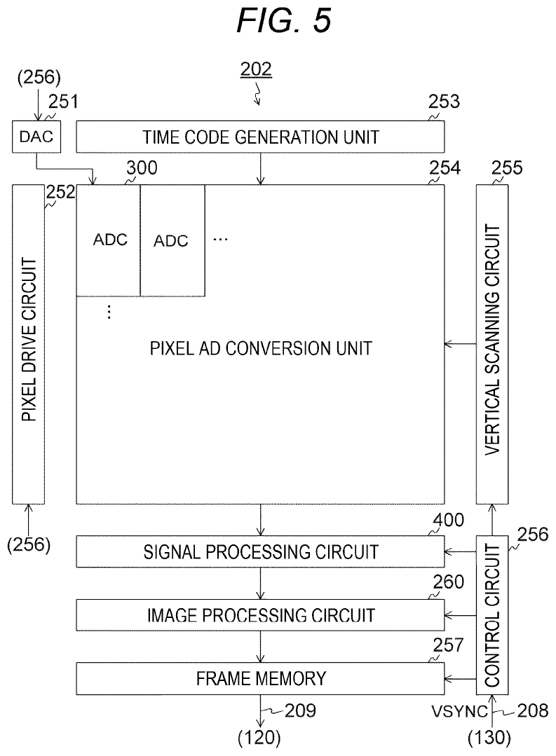

FIG. 5 is a block diagram illustrating a configuration example of the second chip 202. In the second chip 202, a digital to analog converter (DAC) 251, a pixel drive circuit 252, a time code generation unit 253, a pixel AD conversion unit 254, and a vertical scanning circuit 255 are arranged. Moreover, in the second chip 202, a control circuit 256, a signal processing circuit 400, an image processing circuit 260, a frame memory 257, and the like are arranged.

The DAC 251 generates a reference signal REF by performing digital-to-analog (DA) conversion on an input signal within a predetermined AD conversion period. In the present embodiment, a saw-tooth ramp signal is generated as the reference signal REF. The DAC 251 supplies the reference signal REF to the pixel AD conversion unit 254.

The time code generation unit 253 generates a time code indicating a time in the AD conversion period. The time code generation unit 253 is achieved by, for example, a counter. As the counter, for example, a gray code counter is used. The time code generation unit 253 supplies the time code to the pixel AD conversion unit 254.

The pixel drive circuit 252 drives each of the pixels 220 to generate an analog pixel signal.

In the pixel AD conversion unit 254, analog to digital converters (ADCs) 300 as many as the pixels 220 are arranged. Each ADC 310 performs AD conversion for converting an analog pixel signal generated by the corresponding pixel 220 into a digital signal. The pixel AD conversion unit 254 generates, as a frame, image data in which the digital signals of the ADCs 310 are arranged, and transmits the frame to the signal processing circuit 400.

In the AD conversion, for example, each ADC 310 compares an analog pixel signal with the reference signal REF (ramp signal), and holds a time code at a time when a result of comparison is inverted. Subsequently, the ADC 310 outputs the held time code as a digital signal after the AD conversion. Note that a part of circuit configuration of the ADC 310 is arranged in the first chip 201.

The vertical scanning circuit 255 drives the pixel AD conversion unit 254 to execute AD conversion.

The signal processing circuit 400 performs predetermined signal processing on the frame. The signal processing includes, for example, correlated double sampling (CDS) processing and time delayed integration (TDI) processing. The signal processing circuit 400 supplies the processed frame to the image processing circuit 260.

The image processing circuit 260 performs predetermined image processing on the frame from the signal processing circuit 400. The image processing includes, for example, image recognition processing, black level correction processing, image correction processing, demosaic processing, and the like. The image processing circuit 260 stores the processed frame in the frame memory 257.

The frame memory 257 temporarily stores the image data after the image processing in units of frames. For example, a static random access memory (SRAM) can be used as the frame memory 257.

The control circuit 256 controls operation timings of the DAC 251, the pixel drive circuit 252, the vertical scanning circuit 255, the signal processing circuit 400, and the image processing circuit 260 in synchronization with the vertical synchronization signal VSYNC.

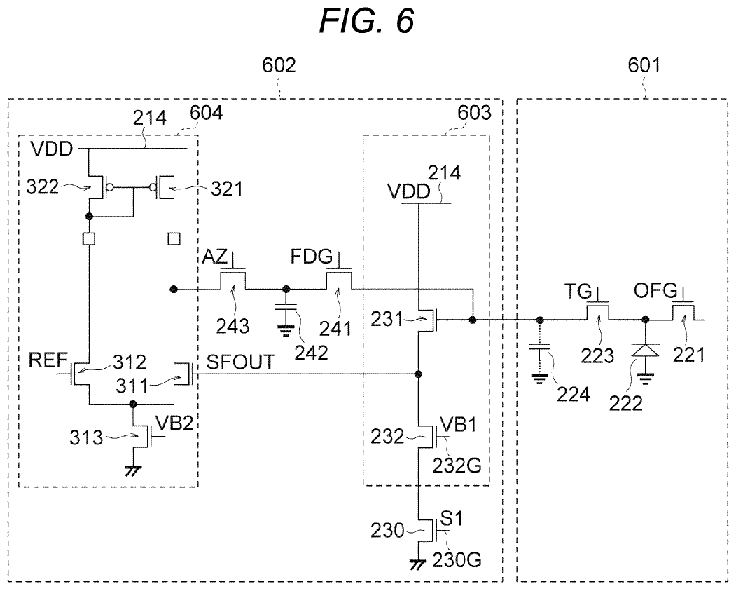

FIG. 6 is a diagram illustrating an example of circuit configuration of the solid-state imaging element 200 according to the first embodiment. As illustrated in FIG. 6, the solid-state imaging element 200 according to the present embodiment includes a light receiving circuit 601 that performs photoelectric conversion on incident light and a reading circuit 602 that reads a signal generated as a result of the photoelectric conversion by the light receiving circuit 601.

First, circuit configuration of the light receiving circuit 601 will be described. The light receiving circuit 601 is provided in each of the plurality of pixels 220 arranged in the pixel array unit 210, and is arranged in the first chip 201. In the light receiving circuit 601 of the present embodiment, a discharge transistor 221, a photoelectric conversion element 222, a transfer transistor 223, and a floating diffusion layer 224 are disposed. For example, n-channel MOS transistors can be used for the discharge transistor 221 and the transfer transistor 223.

The discharge transistor 221 discharges charge accumulated in the photoelectric conversion element 222 in accordance with a discharge signal OFG from the pixel drive circuit 252 (see FIG. 5) described above.

The photoelectric conversion element 222 performs photoelectric conversion on incident light to generate charge. A photodiode can be used as the photoelectric conversion element 222. The photodiode includes, for example, an avalanche photodiode such as a single photon avalanche diode (SPAD).

The transfer transistor 223 transfers the charge accumulated in the photoelectric conversion element 222 to the floating diffusion layer 224 in accordance with a transfer signal TRG from the pixel drive circuit 252.

The floating diffusion layer 224 accumulates the charge transferred from the transfer transistor 223 and generates a pixel signal having a voltage according to the amount of charge.

Next, circuit configuration of the reading circuit 602 will be described. In the reading circuit 602 of the present embodiment, a source follower circuit 603, a first switch element 230, a switching transistor 241, a capacitive element 242, an auto-zero transistor 243, and a current mirror circuit 604 are arranged. The source follower circuit 603, the first switch element 230, the switching transistor 241, the capacitive element 242, and the auto-zero transistor 243 are provided in each pixel 220 and arranged in the first chip 201. In addition, the current mirror circuit 604 is provided in each ADC 300.

The source follower circuit 603 is disposed at a subsequent stage of the light receiving circuit 601, and amplifies an output signal of the light receiving circuit 601. The source follower circuit 603 includes a source follower transistor 231 and a first current source transistor 232. For example, n-channel MOS transistors can be used for these transistors.

A gate of the source follower transistor 231 is connected to one end of the floating diffusion layer 224. Furthermore, a source of the source follower transistor 231 is connected to a drain of the first current source transistor 232. A predetermined first bias voltage VB1, on the other hand, is applied to a gate of the first current source transistor 232 from the pixel drive circuit 252. A source thereof is connected to ground via the first switch element 230. The first current source transistor 232 supplies a current according to the first bias voltage VB1 to the source follower transistor 231.

The first switch element 230 is connected between the source of the first current source transistor 232 and the ground. In the present embodiment, the first switch element 230 is an n-channel MOS transistor. A drain of the first switch element 230 is connected to the source of the first current source transistor 232, and a source of the first switch element 230 is grounded.

A first drive signal S1 is input from the pixel drive circuit 252 to a gate of the first switch element 230 via a gate wiring 230G. The gate wiring 230G is disposed adjacent to a gate wiring 232G connected to the gate of the first current source transistor 232. When the first drive signal S1 is at a high level, the first switch element 230 is turned on. Conversely, when the first drive signal S1 is at a low level, the first switch element 230 is turned off.

The switching transistor 241, the capacitive element 242, and the auto-zero transistor 243 are disposed between the source follower circuit 603 and the current mirror circuit 604. In addition, for example, n-channel MOS transistors can be used for the switching transistor 241 and the auto-zero transistor 243.

A drain of the switching transistor 241 is connected to the floating diffusion layer 224 and the gate of the source follower transistor 231. A source of the switching transistor 241 is connected to one end of the capacitive element 242 and a drain of the auto-zero transistor 243. Another end of the capacitive element 242 is connected to the ground. A switching signal FDG is applied to a gate of the switching transistor 241 from the pixel drive circuit 252. The switching transistor 241 is turned on or off in accordance with the switching signal FDG. As a result, electrical connection between the floating diffusion layer 224 and the capacitive element 242 is switched.

The auto-zero transistor 243 is turned on and off in accordance with an auto-zero signal AZ from the pixel drive circuit 252. When the auto-zero transistor 243 is turned on, a drain of a first differential transistor 311 of the current mirror circuit 604 and an input node of the source follower circuit 603 are short-circuited.

The current mirror circuit 604 is arranged at a subsequent stage of the source follower circuit 603. The current mirror circuit 604 includes a first differential transistor 311, a second differential transistor 312, a second current source transistor 313, a first current transistor 321, and a second current transistor 322. For example, n-channel MOS transistors can be used for the first differential transistor 311, the second differential transistor 312, and the second current source transistor 313. In addition, these transistors are arranged in the first chip 201. On the other hand, p-channel MOS transistors can be used for the first current transistor 321 and the second current transistor 322. These transistors are arranged in the second chip 202.

The first differential transistor 311 and the second differential transistor 312 form a pair. That is, sources of these transistors are both connected to a drain of the second current source transistor 313. A drain of the first differential transistor 311 is connected to a drain of the first current transistor 321. An output signal SFOUT of the source follower circuit 603 is input to a gate of the first differential transistor 311. The output signal SFOUT corresponds to an analog signal subjected to photoelectric conversion by the light receiving circuit 601 and amplified by the source follower transistor 231. A drain of the second differential transistor 312, on the other hand, is connected to a drain and a gate of the second current transistor 322. The reference signal REF from the DAC 251 is input to a gate of the second differential transistor 312.

The power supply voltage VDD is applied to sources of the first current transistor 321 and the second current transistor 322 through the power supply line 214. A predetermined second bias voltage VB2 is applied to a gate of the second current source transistor 313 from the pixel drive circuit 252. A source of the second current source transistor 313 is connected to the ground. The second current source transistor 313 supplies a current according to the second bias voltage VB2 to the current mirror circuit 604.

The current mirror circuit 604 described above functions as a differential amplifier circuit that amplifies a difference between the output signal SFOUT input to the gate of the first differential transistor 311 and the reference signal REF input to the gate of the second differential transistor 312.

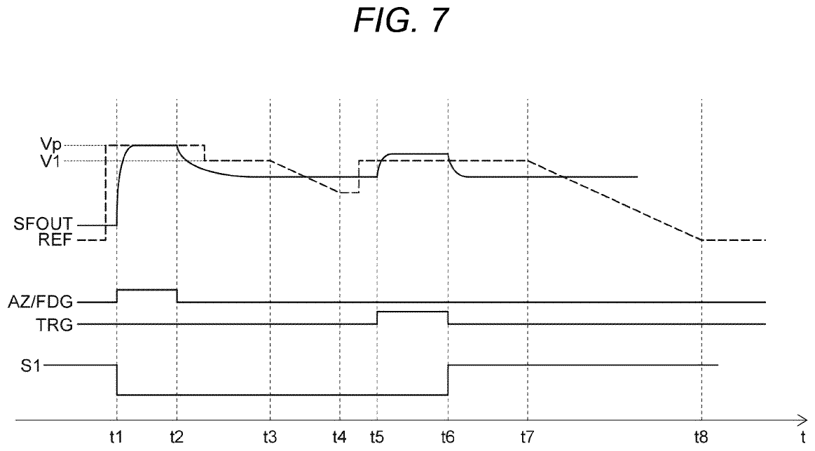

FIG. 7 is a timing chart for explaining operation of the solid-state imaging element 200 according to the first embodiment. FIG. 7 illustrates voltage waveforms of the output signal SFOUT of the source follower circuit 603, the reference signal REF, the auto-zero signal AZ, the switching signal FDG, the transfer signal TRG, and the first drive signal S1.

First, in an auto-zero settling period from a time t1 to a time t2, since the auto-zero signal AZ and the switching signal FDG are at the high level, the auto-zero transistor 243 and the switching transistor 241 are turned on. As a result, the drain of the first differential transistor 311 of the current mirror circuit 604 and the input node of the source follower circuit 603 are short-circuited to each other. At this time, the voltage of each of the output signal SFOUT and the reference signal REF rises to a peak voltage Vp. In addition, since the transfer signal TRG and the first drive signal S1 are at the low level, the transfer transistor 223 and the first switch element 230 are turned off.

Next, in a P-phase settling period from the time t2 to a time t3, since the auto-zero signal AZ and the switching signal FDG are at the low level, the auto-zero transistor 243 and the switching transistor 241 are turned off. At this time, the voltage of the reference signal REF decreases from the peak voltage Vp to a voltage V1, and the voltage of the output signal SFOUT decreases from the peak voltage Vp to a voltage lower than the voltage V1. In addition, since the transfer signal TRG and the first drive signal S1 remain at the low level, the transfer transistor 223 and the first switch element 230 remain turned off.

Next, in a P-phase period from the time t3 to a time t4, since the auto-zero signal AZ and the switching signal FDG remain at the low level, the auto-zero transistor 243 and the switching transistor 241 remain turned off. At this time, the voltage of the output signal SFOUT is constant. The voltage of the reference signal REF, on the other hand, gradually decreases from the voltage V1, matches the voltage of the output signal SFOUT, and then becomes lower than the voltage of the output signal SFOUT. In addition, since the transfer signal TRG and the first drive signal S1 remain at the low level, the transfer transistor 223 and the first switch element 230 remain turned off. In the P-phase period (reset period), a potential of the floating diffusion layer 224 is reset.

Next, in a transfer period from a time t5 to a time t6, since the auto-zero signal AZ and the switching signal FDG remain at the low level, the auto-zero transistor 243 and the switching transistor 241 remain turned off. In addition, since the first drive signal S1 also remains at the low level, the first switch element 230 also remains turned off. Since the transfer signal TRG changes to the high level, on the other hand, the transfer transistor 223 is switched from off to on. As a result, charge accumulated in the photoelectric conversion element 222 in an accumulation period from the time t4 to the time t5 is transferred to the floating diffusion layer 224. As a result, the voltage of the output signal SFOUT becomes higher than the voltage of the reference signal REF.

Next, in a D-phase settling period from the time t6 to a time t7, since the auto-zero signal AZ and the switching signal FDG remain at the low level, the auto-zero transistor 243 and the switching transistor 241 remain turned off. In addition, since the transfer signal TRG changes to the lower level, the transfer transistor 223 is switched from on to off. Since the first drive signal S1 changes to the high level, on the other hand, the first switch element 230 is switched from off to on.

Lastly, in a D-phase period from the time t7 to a time t8, since the auto-zero signal AZ and the switching signal FDG remain at the low level, the auto-zero transistor 243 and the switching transistor 241 remain turned off. In addition, since the transfer signal TRG remains at the low level, the transfer transistor 223 remains turned off. Moreover, since the first drive signal S1 also remains at the low level, the first switch element 230 also remains turned on. In the D-phase period, pixel data according to the amount of charge accumulated in the photoelectric conversion element 222 is read out to the reading circuit 602.

In the solid-state imaging element 200 configured as described above, the first bias voltage VB1 is supplied from the pixel drive circuit 252 to the gate of the first current source transistor 232 even during the period in which the photoelectric conversion element 222 is accumulating charges. Therefore, if the first switch element 230 is not connected between the first current source transistor 232 and the ground, hot carrier luminescence is generated because a Current continues to flow through the first current source transistor 232. The hot carrier luminescence is not light incident from an imaging area. That is, the hot carrier luminescence is not light to be received by the photoelectric conversion element 222. Therefore, if the photoelectric conversion element 222 receives the hot carrier luminescence, dark current characteristics indicating detection characteristics of low-intensity incident light can deteriorate. The deterioration of the dark current characteristics leads to an increase in fixed pattern noise (FPN) and a reduction in a dynamic range.

In the present embodiment, however, the first switch element 230 is connected between the first current source transistor 232 and the ground. The first switch element 230 is turned off under the control of the pixel drive circuit 252 during the charge accumulation period of the photoelectric conversion element 222. Therefore, a current path through the first current source transistor 232 is cut off. This makes it possible to avoid generation of hot carrier luminescence from the first current source transistor 232.

Therefore, according to the present embodiment, it is possible to improve deterioration of dark current characteristics caused by hot carrier luminescence of the first current source transistor 232.

### Second Embodiment

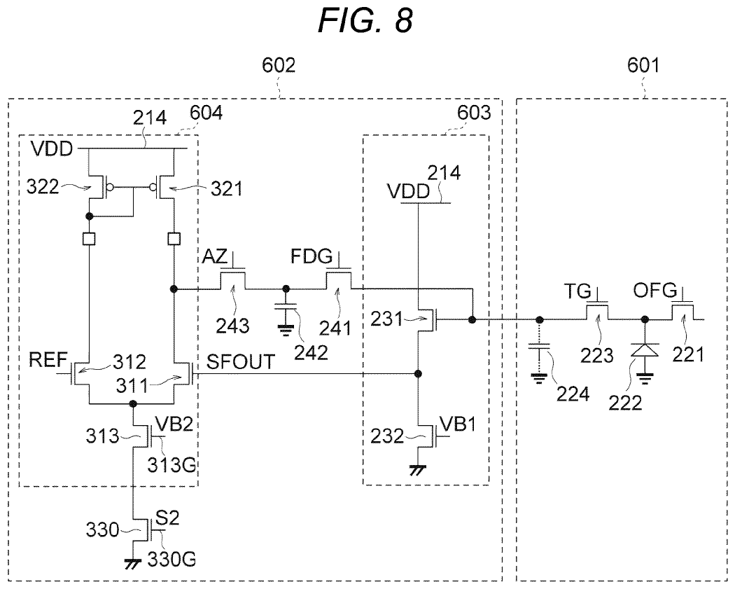

FIG. 8 is a diagram illustrating an example of circuit configuration of a solid-state imaging element according to a second embodiment. In FIG. 8, circuit elements similar to those in the first embodiment are denoted by similar reference signs, and detailed description thereof is omitted. Differences of the second embodiment from the first embodiment will be mainly described hereinafter.

As illustrated in FIG. 8, in the present embodiment, the configuration of the reading circuit 602 is different from that in the first embodiment. In the reading circuit 602 of the present embodiment, a second switch element 330 is provided instead of the first switch element 230. The second switch element 330 is connected between the second current source transistor 313 of the current mirror circuit 604 and the ground. In the present embodiment, the second switch element 330 is disposed in the first chip 201. In addition, in the present embodiment, the second switch element 330 is an n-channel MOS transistor.

A drain of the second switch element 330 is connected to the source of the second current source transistor 313, and a source of the second switch element 330 is grounded. In addition, a second drive signal S2 is input from the pixel drive circuit 252 to a gate of the second switch element 330 via a gate wiring 330G. The gate wiring 330G is disposed adjacent to a gate wiring 313G connected to the gate of the second current source transistor 313. When the second drive signal S2 is at the high level, the second switch element 330 is turned on. Conversely, when the second drive signal S2 is at the low level, the second switch element 330 is turned off. A level of the second drive signal S2 changes at the same timing as the first drive signal S1 illustrated in FIG. 7.

In the solid-state imaging element according to the present embodiment, as in the first embodiment, a current mirror circuit 604 is provided for each pixel 220 for high-speed driving. Each current mirror circuit 604 is provided with a second current source transistor 313. The second bias voltage VB2 is supplied from the pixel drive circuit 252 to the gate of the second current source transistor 313 even during the period in which the photoelectric conversion element 222 is accumulating charges. Therefore, if the second switch element 330 is not connected between the second current source transistor 313 and the ground, hot carrier luminescence is generated because a current continues to flow through the second current source transistor 313. In this case, when the photoelectric conversion element 222 receives hot carrier luminescence, dark current characteristics can deteriorate.

In the present embodiment, however, the second switch element 330 is connected between the second current source transistor 313 and the ground. The second switch element 330 is turned off under the control of the pixel drive circuit 252 during the charge accumulation period of the photoelectric conversion element 222. Therefore, a current path through the second current source transistor 313 is cut off. This makes it possible to avoid generation of hot carrier luminescence from the second current source transistor 313.

Therefore, according to the present embodiment, it is possible to improve deterioration of dark current characteristics caused by hot carrier luminescence of the second current source transistor 313.

### Third Embodiment

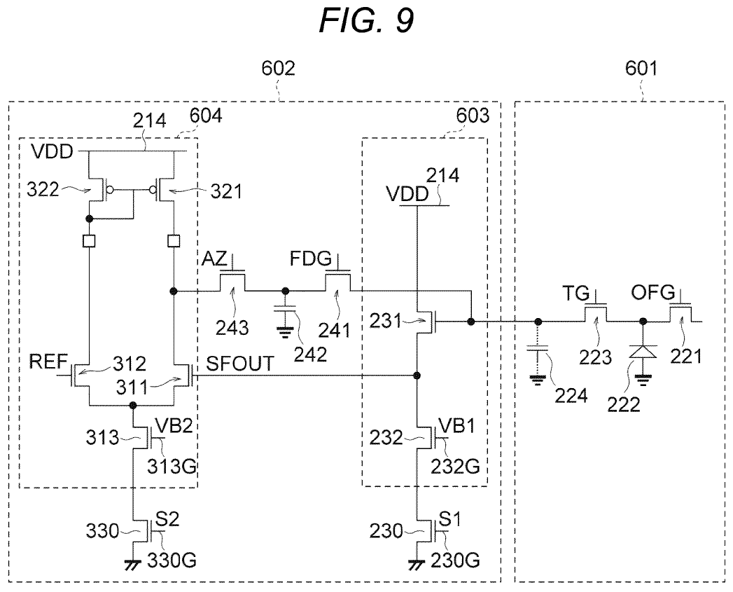

FIG. 9 is a diagram illustrating an example of circuit configuration of a solid-state imaging element according to a third embodiment. In FIG. 9, circuit elements similar to those in the first embodiment and the second embodiment are denoted by similar reference signs, and detailed description thereof is omitted. Differences of the third embodiment from the first embodiment and the second embodiment will be mainly described hereinafter.

As illustrated in FIG. 9, in the present embodiment, the configuration of the reading circuit 602 is different from those in the first embodiment and the second embodiment. The reading circuit 602 of the present embodiment is provided with both the first switch element 230 described in the first embodiment and the second switch element 330 described in the second embodiment. Both the first switch element 230 and the second switch element 330 are disposed in the first chip 201.

In the present embodiment, the first switch element 230 and the second switch element 330 are turned on and off at the same timing under the control of the pixel drive circuit 252. Therefore, during the charge accumulation period of the photoelectric conversion element 222, the first switch element 230 and the second switch element 330 are turned off. Therefore, during this charge accumulation period, both the current path flowing through the first current source transistor 232 and the current path flowing through the second current source transistor 313 are cut off.

Therefore, according to the present embodiment, generation of hot carrier luminescence of both the first current source transistor 232 and the second current source transistor 313 can be avoided, so that the dark current characteristics can be further improved as compared with the first embodiment and the second embodiment.

### Fourth Embodiment

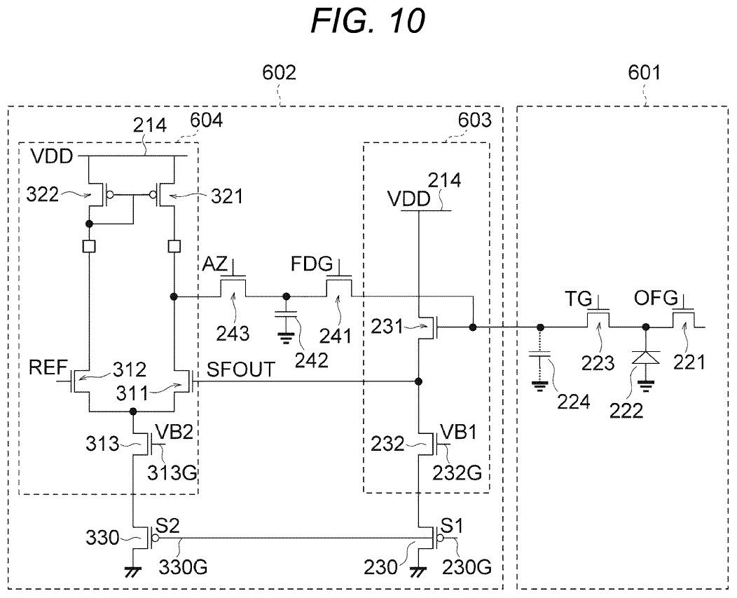

FIG. 10 is a diagram illustrating an example of circuit configuration of a solid-state imaging element according to a fourth embodiment. In FIG. 10, circuit elements similar to those in the third embodiment are denoted by similar reference signs, and detailed description thereof is omitted. Differences of the fourth embodiment from the third embodiment will be mainly described hereinafter.

As illustrated in FIG. 10, in the present embodiment, the configuration of the reading circuit 602 is different from that in the third embodiment. In the reading circuit 602 of the present embodiment, both the first switch element 230 and the second switch element 330 are achieved by p-channel MOS transistors. In addition, the gate wiring 230G of the gate wiring 230G of the first switch element 230 and the gate wiring 330G of the second switch element 330 are made common and connected to the pixel drive circuit 252.

In the present embodiment, too, the first switch element 230 and the second switch element 330 are turned on and off at the same timing. In the present embodiment, however, since each switch element is achieved by a p-channel MOS transistor, the levels of the first drive signal S1 and the second drive signal S2 are opposite to that of the first drive signal S1 illustrated in FIG. 7. That is, in the present embodiment, the first drive signal S1 and the second drive signal S2 become the high level from the time t1 to the time t6, and become the low level after the time t6.

In the present embodiment, as in the third embodiment, during the charge accumulation period of the photoelectric conversion element 222, the first switch element 230 and the second switch element 330 are turned off. Therefore, during this charge accumulation period, both the current path flowing through the first current source transistor 232 and the current path flowing through the second current source transistor 313 are cut off. This makes it possible to avoid generation of hot carrier luminescence from the first current source transistor 232 and the second current source transistor 313.

Therefore, according to the present embodiment, as in the third embodiment, it is possible to improve deterioration of dark current characteristics caused by hot carrier luminescence of both the first current source transistor 232 and the second current source transistor 313.

In addition, in the present embodiment, the gate wiring 230G of the first switch element 230 and the gate wiring 330G of the second switch element 330 are made common. Therefore, wiring area can be reduced. Note that, also in the third embodiment in which the first switch element 230 and the second switch element 330 are achieved by n-channel MOS transistors, the gate wiring 230G of the first switch element 230 and the gate wiring 330G of the second switch element 330 may be made common.

### Fifth Embodiment

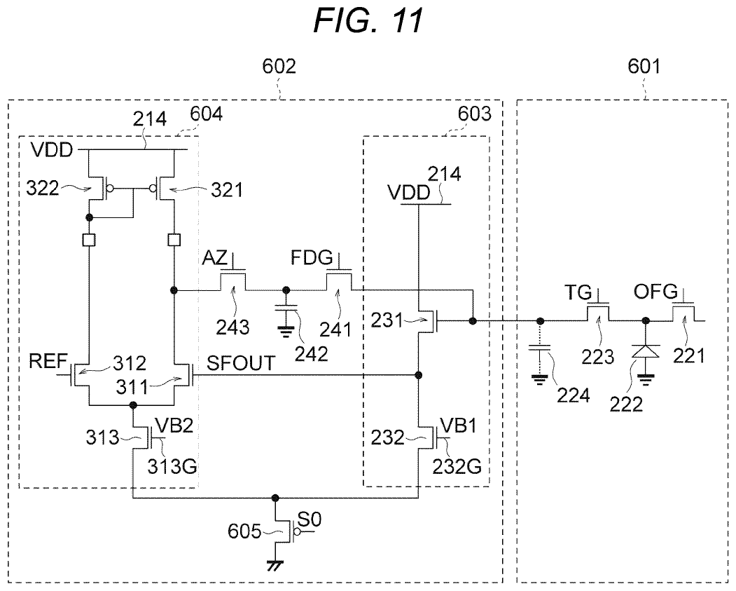

FIG. 11 is a diagram illustrating an example of circuit configuration of a solid-state imaging element according to a fifth embodiment. In FIG. 11, circuit elements similar to those in the fourth embodiment are denoted by similar reference signs, and detailed description thereof is omitted. Differences of the fifth embodiment from the fourth embodiment will be mainly described hereinafter.

As illustrated in FIG. 11, in the present embodiment, the configuration of the reading circuit 602 is different from that in the third embodiment. In the reading circuit 602 of the present embodiment, one switch element 605 is provided for the first current source transistor 232 and the second current source transistor 313. That is, in the present embodiment, the first switch element 230 connected to the first current source transistor 232 and the second switch element 330 connected to the second current source transistor 313 are shared as one switch element 605.

The switch element 605 is a p-channel MOS transistor. A source of the switch element 605 is connected to each of the sources of the first current source transistor 232 and the second current source transistor 313. In addition, the drain of the switch element 605 is grounded. A drive signal S0 is input from the pixel drive circuit 252 to a gate of the switch element 605.

The switch element 605 is turned on by the low-level drive signal S0 and turned off by the high-level drive signal S0. In the present embodiment, the drive signal S0 becomes the high level from the time t1 to the time t6 in the timing chart illustrated in FIG. 7, and becomes the low level after the time t6. Therefore, in the present embodiment, as in the fourth embodiment, during the charge accumulation period of the photoelectric conversion element 222, the switch element 605 is turned off. Therefore, during this charge accumulation period, both the current path flowing through the first current source transistor 232 and the current path flowing through the second current source transistor 313 are cut off. This makes it possible to avoid generation of hot carrier luminescence from the first current source transistor 232 and the second current source transistor 313.

Therefore, according to the present embodiment, as in the fourth embodiment, it is possible to improve deterioration of dark current characteristics caused by hot carrier luminescence of both the first current source transistor 232 and the second current source transistor 313.

In addition, in the present embodiment, the switch element 605 is connected to both the first current source transistor 232 and the second current source transistor 313. Therefore, the number of switch elements can be reduced as compared with the fourth embodiment. This makes it possible to reduce area of the switch element. Note that the switch element 605 may be a n-channel MOS transistor, instead.

### Sixth Embodiment

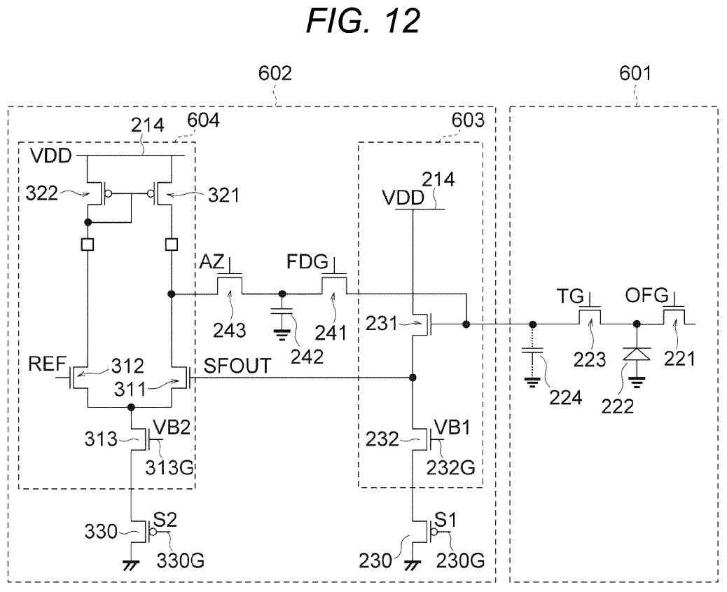

FIG. 12 is a diagram illustrating an example of circuit configuration of a solid-state imaging element according to a sixth embodiment. In FIG. 12, circuit elements similar to those in the fourth embodiment are denoted by similar reference signs, and detailed description thereof is omitted. Differences of the sixth embodiment from the fourth embodiment will be mainly described hereinafter.

In the present embodiment, as in the fourth embodiment, while both the first switch element 230 and the second switch element 330 are p-channel MOS transistors, a layout of gate wirings of the switch elements is different from that of the fourth embodiment.

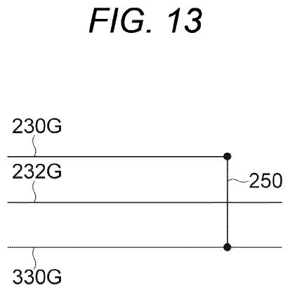

FIG. 13 is a diagram illustrating an example of the layout of the gate wirings of the switch elements according to the sixth embodiment. In FIG. 13, the gate wiring 230G of the first switch element 230 and the gate wiring 330G of the second switch element 330 are parallel to the gate wiring 232G of the first current source transistor 232. In addition, the gate wiring 232G is disposed between the gate wiring 230G and the gate wiring 330G. That is, the gate wiring 230G and the gate wiring 330G are arranged in such a way as to be adjacent to the gate wiring 232G. In addition, the gate wiring 230G and the gate wiring 330G are connected to each other by a wiring 250.

In the present embodiment, the gate wiring 230G and the gate wiring 330G are arranged in such a way as to be adjacent to the gate wiring 232G, and a guard ring is formed by a ground line to suppress coupling of the gate wiring 232G.

Note that, in the present embodiment, the gate wiring 230G and the gate wiring 330G are arranged adjacent to the gate wiring 232G of the first current source transistor 232, but may be arranged adjacent to the gate wiring 313G of the second current source transistor 313. In this case, coupling of the gate wiring 313G can be suppressed.

### Seventh Embodiment

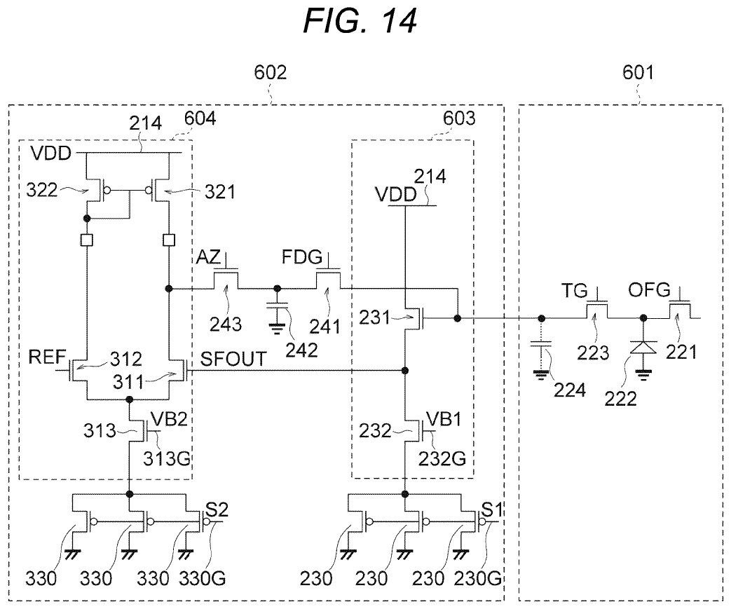

FIG. 14 is a diagram illustrating an example of circuit configuration of a solid-state imaging element according to a seventh embodiment. In FIG. 14, circuit elements similar to those in the fourth embodiment are denoted by similar reference signs, and detailed description thereof is omitted. Differences of the fourth embodiment from the seventh embodiment will be mainly described hereinafter.

In the present embodiment, a plurality of first switch elements 230 is connected to the first current source transistor 232 in parallel with each other. In addition, a plurality of second switch elements 330 is connected to the second current source transistor 313 in parallel with each other. Similarly to the fourth embodiment, each of the first switch elements 230 and each of the second switch elements 330 is a p-channel MOS transistor.

The gate wirings 230G of the first switch elements 230 are made common and connected to the pixel drive circuit 252. Each first switch element 230 is turned on and off on the basis of the first drive signal S1 input from the pixel drive circuit 252 to a gate thereof through the gate wiring 230G.

The gate wirings 230G of the second switch elements 330, on the other hand, are also made common and connected to the pixel drive circuit 252. Each second switch element 330 is turned on and off on the basis of the second drive signal S2 input from the pixel drive circuit 252 to a gate thereof through the gate wiring 330G. At this time, each second switch element 330 is turned on and off at the same timing as each first switch element 230.

In the present embodiment, too, during the charge accumulation period of the photoelectric conversion element 222, the first switch elements 230 and the second switch elements 330 are turned off. Therefore, during this charge accumulation period, both the current path flowing through the first current source transistor 232 and the current path flowing through the second current source transistor 313 are cut off. This makes it possible to avoid generation of hot carrier luminescence from the first current source transistor 232 and the second current source transistor 313.

Therefore, according to the present embodiment, it is possible to improve deterioration of dark current characteristics caused by hot carrier luminescence of both the first current source transistor 232 and the second current source transistor 313.

In addition, in the present embodiment, since the plurality of first switch elements 230 is connected in parallel with each other, a large current can flow through the source follower circuit 603 when each of the first switch elements 230 is turned on. Moreover, since the plurality of second switch elements 330 is connected in parallel with each other, a large current can flow through the current mirror circuit 604 when each of the second switch elements 330 is turned on. Note that, in the present embodiment, each switch element is a p-channel MOS transistor, but may be an n-channel MOS transistor, instead.

### Eighth Embodiment

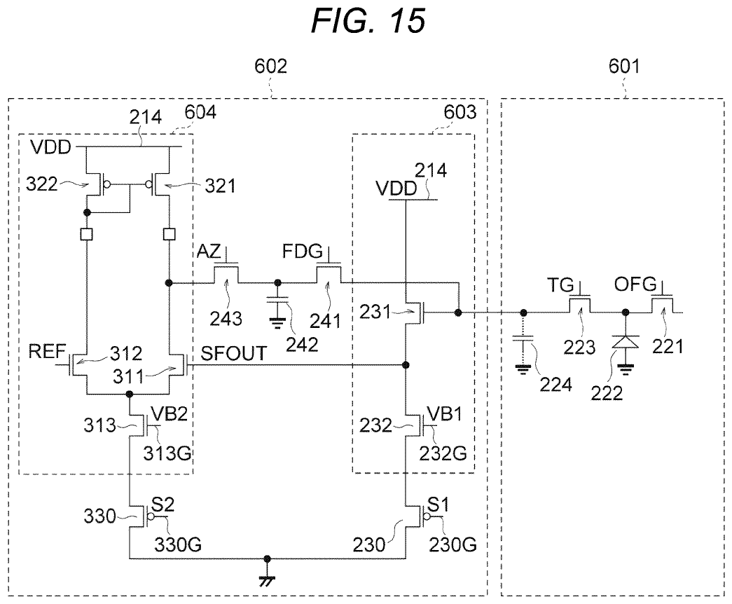

FIG. 15 is a diagram illustrating an example of circuit configuration of a solid-state imaging element according to an eighth embodiment. In FIG. 15, circuit elements similar to those in the eighth embodiment are denoted by similar reference signs, and detailed description thereof is omitted. Differences of the eighth embodiment from the fourth embodiment will be mainly described hereinafter.

In the present embodiment, the ground is made common between the first switch element 230 and the second switch element 330. That is, the drain of the first switch element 230 and the drain of the second switch element 330 are commonly connected to a ground region formed in the first chip 201.

Therefore, because a potential difference between the drain of the first switch element 230 and the drain of the second switch element 330 is substantially eliminated, a switch operation of the first switch element 230 and the second switch element 330 is stabilized. This makes it possible to avoid generation of hot carrier luminescence from the first current source transistor 232 and the second current source transistor 313 during the charge accumulation period of the photoelectric conversion element 222 more reliably. Therefore, it is possible to further improve deterioration of dark current characteristics caused by hot carrier luminescence of both the first current source transistor 232 and the second current source transistor 313.

### Example of Application to Mobile Body

The technology according to the present disclosure (the present technology) can be applied to various products. For example, the technology according to the present disclosure may also be implemented as a device mounted on any type of mobile body such as an automobile, an electric automobile, a hybrid electric automobile, a motorcycle, a bicycle, a personal mobility, an airplane, a drone, a ship, and a robot.

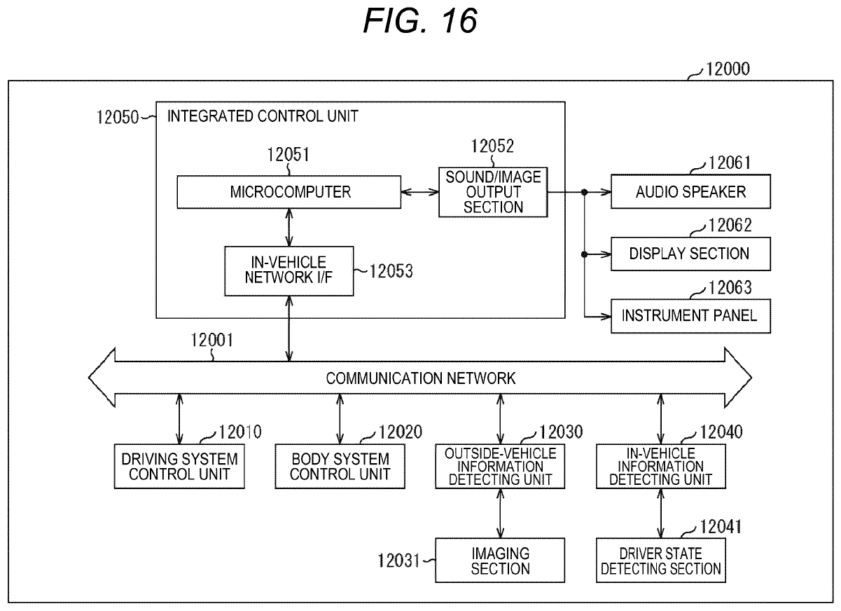

FIG. 16 is a block diagram illustrating an example of a schematic configuration of a vehicle control system as an example of a mobile body control system to which the technology in the present disclosure can be applied.

The vehicle control system 12000 includes a plurality of electronic control units connected to each other via a communication network 12001. In the example illustrated in FIG. 16, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and an in-vehicle network interface (I/F) 12053 are illustrated as functional components of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

Furthermore, the microcomputer 12051 can output a control command to the body system control unit 12020, on the basis of the information regarding the outside of the vehicle acquired by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 16, an audio speaker 12061, a display section 12062, and an instrument panel 12063 are illustrated as the output device. The display section 12062 may, for example, include at least one of an on-board display and a head-up display.

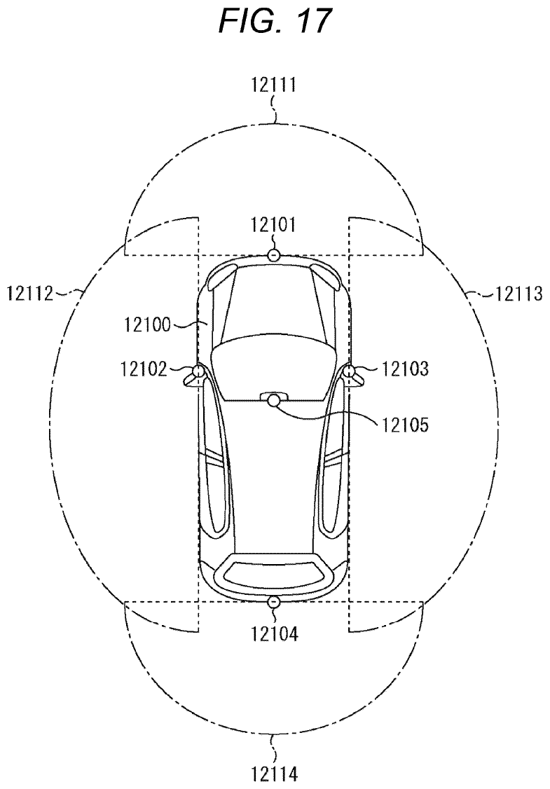

FIG. 17 is a diagram illustrating an example of the installation position of the imaging section 12031.

In FIG. 17, the vehicle 12100 includes imaging sections 12101, 12102, 12103, 12104, and 12105 as the imaging section 12031.

The imaging sections 12101, 12102, 12103, 12104, and 12105 are provided at, for example, positions such as a front nose, a sideview mirror, a rear bumper, a back door, or upper portion of a windshield within the interior of the vehicle 12100. The imaging section 12101 provided to the front nose and the imaging section 12105 provided to the upper portion of the windshield within the interior of the vehicle obtain mainly an image of the front of the vehicle 12100. The imaging sections 12102 and 12103 provided for the sideview mirrors mainly obtain images of the sides of the vehicle 12100. The imaging section 12104 provided to the rear bumper or the back door obtains mainly an image of the rear of the vehicle 12100. Images of the front to be obtained by the imaging sections 12101 and 12105 are used mainly to detect a preceding vehicle, a pedestrian, an obstacle, a traffic signal, a traffic sign, a lane, or the like.

Note that FIG. 17 illustrates an example of imaging ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology in the present disclosure can be applied has been described above. The technology in the present disclosure can be applied, for example, to the imaging section 12031 among the components described above. Specifically, the solid-state imaging element described above can be implemented as the imaging section 12031. Since dark current characteristics are improved by applying the technology in the present disclosure to the imaging section 12031, accurate distance information can be obtained. As a result, functionality and safety of the vehicle 12100 can be enhanced.

Note that the present technology can also have the following configurations.

(1) A solid-state imaging element including:
a light receiving circuit that performs photoelectric conversion on incident light; and
a reading circuit that reads a signal obtained as a result of the photoelectric conversion by the light receiving circuit, in which
the reading circuit includes:
one or more current source transistors; and
one or more switch elements connected between the current source transistors and ground.

(2) The solid-state imaging element according to (1), in which the reading circuit further includes:
a source follower circuit disposed at a subsequent stage of the light receiving circuit; and
a current mirror circuit disposed at a subsequent stage of the source follower circuit,
the source follower circuit includes a first current source transistor among the current source transistors, and
the current mirror circuit includes a second current source transistor among the current source transistors, which is different from the first current source transistor.

(3) The solid-state imaging element according to (2), in which a first switch element among the switch elements is connected between the first current source transistors and the ground.

(4) The solid-state imaging element according to (2), in which a second switch element among the switch elements is connected between the second current source transistors and the ground.

(5) The solid-state imaging element according to (2), in which a first switch element among the switch elements is connected between the first current source transistor and the ground, and
a second switch element among the switch elements, which is different from the first switch element, is connected between the second current source transistor and the ground.

(6) The solid-state imaging element according to (5), in which a gate wiring of the first switch element is made common with a gate wiring of the second switch element.

(7) The solid-state imaging element according to (2), in which one of the switch elements is commonly connected to the first current source transistor and the second current source transistor.

(8) The solid-state imaging element according to any one of (1) to (7), in which the switch elements are n-channel MOS transistors.

(9) The solid-state imaging element according to any one of (1) to (7), in which the switch elements are p-channel MOS transistors.

(10) The solid-state imaging element according to (2), in which gate wirings of the switch elements are parallel to a gate wiring of the first current source transistor or the second current source transistor.

(11) The solid-state imaging element according to (10), in which the gate wiring of the first current source transistor or the second current source transistor is disposed between the gate wiring of the first switch element among the switch elements and the second switch elements among the switch elements, which is different from the first switch element.

(12) The solid-state imaging element according to (2), in which a plurality of the switch elements is connected in parallel with the first current source transistor and the second current source transistor.

(13) The solid-state imaging element according to (5), in which the ground is made common between the first switch element and the second switch element.

(14) The solid-state imaging element according to any one of (1) to (13), further including:
a pixel drive circuit that controls driving of the switch elements.

(15) The solid-state imaging element according to (14), in which the light receiving circuit includes a photoelectric conversion element that accumulates charge obtained as a result of the photoelectric conversion of the incident light, and
the pixel drive circuit turns off the switch elements during a charge accumulation period of the photoelectric conversion element.

(16) The solid-state imaging element according to any one of (1) to (15), in which the light receiving circuit, the current source transistors, and the switch elements are disposed in a same chip.

(17) The solid-state imaging element according to (16), further including:
a first chip in which the light receiving circuit, the current source transistors, and the switch elements are disposed; and
a second chip that is stacked on the first chip and on which a part of the reading circuit is disposed.

### REFERENCE SIGNS LIST

201 First chip
202 Second chip
222 Photoelectric conversion element
232 First current source transistor
232G Gate wiring
230 First switch element
230G Gate wiring
252 Pixel drive circuit
313 Second current source transistor
313G Gate wiring
330 Second switch element
330G Gate wiring
601 Light receiving circuit
602 Reading circuit
603 Source follower circuit
604 Current mirror circuit

1. A solid-state imaging element comprising:
a light receiving circuit that performs photoelectric conversion on incident light; and
a reading circuit that reads a signal obtained as a result of the photoelectric conversion by the light receiving circuit, wherein
the reading circuit includes:
one or more current source transistors; and
one or more switch elements connected between the current source transistors and ground.

2. The solid-state imaging element according to claim 1, wherein the reading circuit further includes:
a source follower circuit disposed at a subsequent stage of the light receiving circuit; and
a current mirror circuit disposed at a subsequent stage of the source follower circuit,
the source follower circuit includes a first current source transistor among the current source transistors, and
the current mirror circuit includes a second current source transistor among the current source transistors, which is different from the first current source transistor.

3. The solid-state imaging element according to claim 2, wherein a first switch element among the switch elements is connected between the first current source transistor and the ground.

4. The solid-state imaging element according to claim 2, wherein a second switch element among the switch elements is connected between the second current source transistors and the ground.

5. The solid-state imaging element according to claim 2, wherein a first switch element among the switch elements is connected between the first current source transistor and the ground, and
a second switch element among the switch elements, which is different from the first switch element, is connected between the second current source transistor and the ground.

6. The solid-state imaging element according to claim 5, wherein a gate wiring of the first switch element is made common with a gate wiring of the second switch element.

7. The solid-state imaging element according to claim 2, wherein one of the switch elements is commonly connected to the first current source transistor and the second current source transistor.

8. The solid-state imaging element according to claim 1, wherein the switch elements are n-channel MOS transistors.

9. The solid-state imaging element according to claim 1, wherein the switch elements are p-channel MOS transistors.

10. The solid-state imaging element according to claim 2, wherein gate wirings of the switch elements are parallel to a gate wiring of the first current source transistor or the second current source transistor.

11. The solid-state imaging element according to claim 10, wherein the gate wiring of the first current source transistor or the second current source transistor is disposed between the gate wiring of the first switch element among the switch elements and the second switch elements among the switch elements, which is different from the first switch element.

12. The solid-state imaging element according to claim 2, wherein a plurality of the switch elements is connected in parallel with the first current source transistor and the second current source transistor.

13. The solid-state imaging element according to claim 5, wherein the ground is made common between the first switch element and the second switch element.

14. The solid-state imaging element according to claim 1, further comprising:
a pixel drive circuit that controls driving of the switch elements.

15. The solid-state imaging element according to claim 14, wherein the light receiving circuit includes a photoelectric conversion element that accumulates charge obtained as a result of the photoelectric conversion of the incident light, and
the pixel drive circuit turns off the switch elements during a charge accumulation period of the photoelectric conversion element.

16. The solid-state imaging element according to claim 1, wherein the light receiving circuit, the current source transistors, and the switch elements are disposed in a same chip.

17. The solid-state imaging element according to claim 16, further comprising:
a first chip in which the light receiving circuit, the current source transistors, and the switch elements are disposed; and
a second chip that is stacked on the first chip and on which a part of the reading circuit is disposed.
